(19) United States
(12) Patent Application Publication
(10) Pub. No.: US 2017/0187837 A1
(43) Pub. Date: Jun. 29, 2017

(54) AD DOWNLOAD METHOD, THE CLIENT AND THE SERVER

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo AO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,561

(22) Filed: Aug. 22, 2016

Related U.S. Application Data
(63) Continuation of application No. PCT/CN2016/089553, filed on Jul. 10, 2016.

(30) Foreign Application Priority Data
Dec. 29, 2015 (CN) 201511019752.3

(51) Int. Cl. H04L 29/08; G06Q 30/02

(52) U.S. Cl. CPC H04L 67/34; H04L 67/20; H04L 67/327; G06Q 30/0277

(57) ABSTRACT

Embodiments of this disclosure provide an advertisement-downloading method, and an electronic device, wherein the method includes: in response to an operation, of sending an advertisement request that includes a link address of a third-party advertisement, of a client, searching whether the third-party advertisement downloaded from the link address of the third-party advertisement is pre-stored in a local CDN file address; and when the third-party advertisement downloaded from the link address of the third-party advertisement is pre-stored in the local CDN file address, redirect the advertisement request to the local CDN file address in which the third-party advertisement is stored, such that the client performs advertisement downloading.

### CROSS-REFERENCE TO RELATED APPLICATIONS

The present disclosure is a continuation of international application No. PCT/CN2016/089553 filed on Jul. 10, 2016. This application is based upon and claims priority to Chinese Patent Application No. 201511019752.3, filed on Dec. 29, 2015, the entire contents of which are incorporated herein by reference.

### TECHNICAL FIELD

Embodiments of this disclosure relate to information processing technologies, and more specifically, to an advertisement-downloading method, and an electronic device.

### BACKGROUND

A current process of request, by a client application, to obtain a third-party advertisement is: directly sending an advertisement request to a local server; determining, by the local server, that the request is a request for a third-party advertisement, and then returning a link address of a CDN network address where the third-party advertisement is allocated to the client; and then downloading, by the client, the advertisement file from the CDN network address where the third-party advertisement is allocated, and playing the advertisement file.

However, a disadvantage of the manner is: if a network environment is poor or a serving capacity of a third-party advertisement server is poor, file downloading failures and advertisement file damages may possibly occur. Moreover, because the advertisement file is stored on the third-party advertisement server, target advertisement content may be modified, but the client cannot sense the modification and perform in-time remedy operations.

### SUMMARY

This disclosure provides an advertisement-downloading method, and an electronic device, which can quickly request for and download a third-party advertisement file, so as to ensure smooth play of the advertisement.

According to the first aspect, an embodiment of this disclosure provides an advertisement-downloading method, where the method includes: in response to an operation, of sending an advertisement request that includes a link address of a third-party advertisement, of a client, searching whether the third-party advertisement downloaded from the link address of the third-party advertisement is pre-stored in a local CDN file address; and when the third-party advertisement downloaded from the link address of the third-party advertisement is pre-stored in the local CDN file address, redirecting the advertisement request to the local CDN file address in which the third-party advertisement is stored, such that the client performs advertisement downloading.

According to the second aspect, there is provided with a non-transitory computer-readable storage medium storing executable instructions that, when executed by an electronic apparatus, cause the electronic apparatus to perform any one of above disclosed advertisement-downloading method.

According to the third aspect, there is provided with an electronic apparatus. The electronic apparatus includes: at least one processor; and a memory communicably connected with the at least one processor for storing instructions executable by the at least one processor, wherein execution of the instructions by the at least one processor causes the at least one processor to perform any one of above disclosed advertisement-downloading method.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating an advertisement-downloading method according to one embodiment of this disclosure;

FIG. 2 is a flowchart illustrating an advertisement-downloading method according to another embodiment of this disclosure;

FIG. 3 is a flowchart illustrating an advertisement-downloading method according to still another embodiment of this disclosure;

FIG. 4 is a structural block diagram illustrating a server provided according to one embodiment of this disclosure;

FIG. 5 is a structural block diagram illustrating a server according to another embodiment of this disclosure;

FIG. 6 is a structural block diagram illustrating a client provided according to one embodiment of this disclosure;

FIG. 7 is a structural block diagram illustrating a client according to another an embodiment of this disclosure; and

FIG. 8 is a schematic structural diagram of an electronic device provided in an embodiment of this disclosure.

### DETAILED DESCRIPTION

A basic inventive concept of embodiments of this disclosure is to pre-download a third-party advertisement from a link address of the third-party advertisement, and store the third-party advertisement into a local CDN file address; in this way, when a client requests for the third-party advertisement each time, the client may be the first one to acquire the third-party advertisement from the local CDN file address without having to acquire the third-party advertisement from the link address of the third-party advertisement each time.

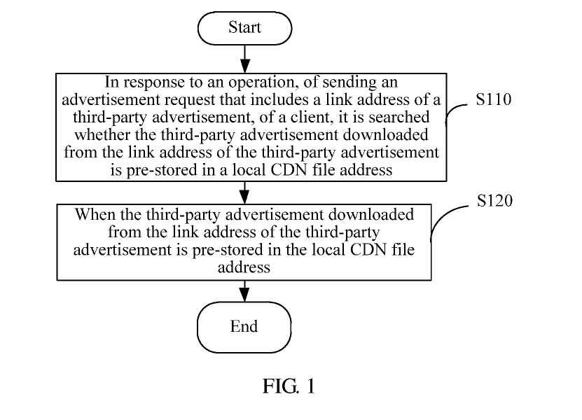

FIG. 1 is a flowchart illustrating an advertisement-downloading method according to one embodiment of this disclosure; wherein an enforcement object of the method may be a local server corresponding to a client that sends an advertisement request.

With reference to FIG. 1, in step S110, in response to an operation, of sending an advertisement request that includes a link address of a third-party advertisement, of a client, it is searched whether the third-party advertisement downloaded from the link address of the third-party advertisement is pre-stored in a local CDN file address.

In the prior art, to acquire data of a third-party advertisement, a client first needs to use a local server to acquire a link address of the third-party advertisement, and then send an advertisement request that includes the link address of the third-party advertisement to the local server, such that the server redirects the request to the link address of the third-party advertisement, and then the client downloads the third-party advertisement from the link address of the third-party advertisement and plays the third-party advertisement.

To avoid downloading failures due to a bad network environment in which the client downloads the third-party advertisement from the link address of the third-party advertisement, or potential risks, which may not be sensed by the client, of modification of the third-party advertisement, the local server pre-downloads the third-party advertisement from the link address of the third-party advertisement, and stores the third-party advertisement in a local CDN file address. Specifically, when the client requests forth a third-party advertisement for a first time, the local server may download the third-party advertisement, and store the third-party advertisement locally, or periodically collect data of the third-party advertisement. This embodiment makes no limitation to a manner for acquiring a third-party advertisement.

Differing from the process of the prior art, in this embodiment, after receiving the advertisement request that includes the link address of the third-party advertisement, the server first searches whether the third-party advertisement requested by the above client and downloaded from the link address of the third-party advertisement is pre-stored in the local CDN file address.

In step S120, when the third-party advertisement downloaded from the link address of the third-party advertisement is pre-stored in the local CDN file address, the advertisement request is redirected to the local CDN file address in which the third-party advertisement is stored, such that the client performs advertisement downloading.

Specifically, when the local server finds, in the local CDN file address, the third-party advertisement requested by the current client and downloaded from the link address of the third-party advertisement, the local server redirects the advertisement request sent by the client to the local CDN file address in which the third-party advertisement is stored, such that the client downloads the advertisement and plays the advertisement.

With the advertisement-downloading method according to this embodiment of this disclosure, by pre-downloading a third-party advertisement stored in a link address of the third-party advertisement into a local CDN, a client first searches for and downloads the third-party advertisement in a local CDN file address when requesting for the third-party advertisement each time, thereby improving file downloading speed and quality and ensuring smooth play of the advertisement. Replacing some frame data in original video stream data with frame data of an advertisement to be inserted, so as to implement advertisement insertion on a basis of not affecting play duration.

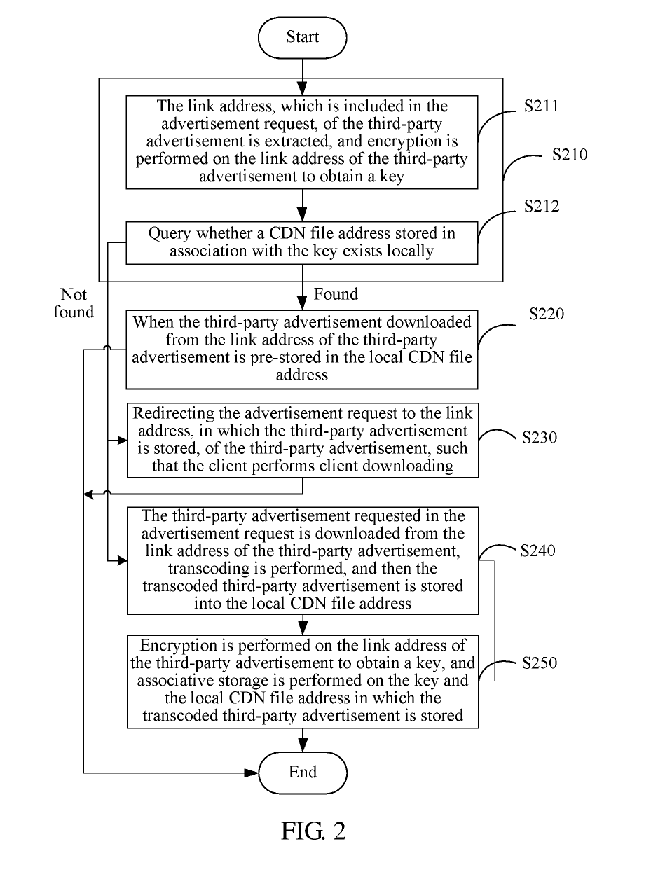

FIG. 2 is a flowchart illustrating an advertisement-downloading method according to another embodiment of this disclosure. This embodiment may be considered as a specific implementation manner of the embodiment as illustrated in FIG. 1.

With reference to FIG. 2, in step S210, in response to an operation, of sending an advertisement request that includes a link address of a third-party advertisement, of a client, it is searched whether the third-party advertisement downloaded from the link address of the third-party advertisement is pre-stored in a local CDN file address. Content of step S210 is similar to that of step S110.

A sample of sending, by a client, an advertisement request that includes a link address of a third-party advertisement is listed hereinafter:

http://play.g3proxy.lecloud.com/vod/v2?adid=10032&u=http://f1.p0y.cn/c/524/3 83500.mp4

wherein the parameter u is the link address of the third-party advertisement:

http://f1.p0y.cn/c/524/383500.mp4

Specifically, step S210 may be implemented by performing the following steps (S211-S212).

In step S211, the link address, which is included in the advertisement request, of the third-party advertisement is extracted, and encryption is performed on the link address of the third-party advertisement to obtain a key.

For example, the link address, which is included in the above advertisement request, of the third-party advertisement is extracted:

http://f1.p0y.cn/c/524/383500.mp4

Encryption, for example, MD5, is performed on the link address of the third-party advertisement to obtain a key:

“bfc1d2cc8886f4de7045a4245afd0cff”

It should be noted herein that the specific method for performing encryption on the link address of the third-party advertisement to obtain the key in the present solution is not limited to the MD5 encryption method.

In step S212, it is queried whether a CDN file address stored in association with the key exists locally, and if the CDN file address stored in association with the key exists locally, it is determined that the third-party advertisement downloaded from the link address of the third-party advertisement is pre-stored in the local CDN file address.

When storing the third-party advertisement downloaded from the link address of the third-party advertisement locally, a local server performs associative storage on the stored third-party advertisement and the key corresponding thereto, and the key is obtained by performing encryption on the original link address, where the third-party advertisement is allocated, of the third-party advertisement according to the above method.

For example, for the above key: “bfc1d2cc8886f4de7045a4245afd0cff”, this embodiment provides a local CDN file address sample corresponding thereto:

http://g3.letv.com/vod/v1/MTY2LzQ4LzgyL2xldHYtZ3VnLzE3L3Zlcl8wMF8y Mi0zMjkwMTcxOTItYXZjLTM2NTI2MClhYWMtNjQlMzMtMTUwMDAtODI4MTM4 LWElNjMxMDg0YzclOGY2NTJlNTU2NzMxZDhiNmU2ZWU0LTEONDglMDgzNzU2 MDAubXA0?platid=100&splatid=10000&gugtype=1&mmsid=37859807&type=pc_liucha ng_mp4

Therefore, after the key is obtained by performing encryption on the link address that is of the third-party advertisement and that is in the advertisement request sent by the current client, by performing searching locally only on the key, it may be known whether the advertisement requested in the current advertisement request is stored in the local CDN file address. If the key is stored locally in the server, it is determined that the third-party advertisement requested by the client and downloaded from the link address of the third-party advertisement is pre-stored in the local CDN file address. The server may obtain a specific storage location of the third-party advertisement according to an associative storage relationship between the key and the local CDN file address.

In step S220, when the third-party advertisement downloaded from the link address of the third-party advertisement is pre-stored in the local CDN file address, the advertisement request is redirected to the local CDN file address in which the third-party advertisement is stored, such that the client performs advertisement downloading. S220 is similar to step S120.

Specifically, after the server finds the third-party advertisement requested by the client locally, the server may return a status code 302 to the client, and redirect, for example, the advertisement request:

http://play.g3proxy.lecloud.com/vod/v2?adid=10032&u=http://f1.p0y.cn/c/524/3 83500.mp4 to the local CDN file address of the server, such that the client downloads a third-party advertisement file from the address, and plays the third-party advertisement file.

As a case contrary to the case of step S220, if the server does not find, in the local CDN file address, the third-party advertisement requested by the client and downloaded from the link address of the third-party advertisement, the server executes step S230 of redirecting the advertisement request to the link address, in which the third-party advertisement is stored, of the third-party advertisement, such that the client performs client downloading.

For example, when the server does not find, in the local CDN file address, the third-party advertisement requested by the current client, the server may return the status code 302 to the client, and redirect, for example, the advertisement request:

http://play.g3proxy.lecloud.com/vod/v2?adid=10032&u=http://f1.p0y.cn/c/524/3 83500.mp4

to the link address of the third-party advertisement, that is:

http://f1.p0y.cn/c/524/383500.mp4, such that the client continues to download the third-party advertisement file from the address and play the third-party advertisement file.

In an embodiment, if the server does not find, in the local CDN file address, the third-party advertisement requested by the client and downloaded from the third-party CDN file address, the server may further execute steps S240-S250.

S240: The third-party advertisement requested in the advertisement request is downloaded from the link address of the third-party advertisement, transcoding is performed, and then the transcoded third-party advertisement is stored into the local CDN file address.

The transcoding processing is transforming the downloaded third-party advertisement into data stream code forms suitable to be played at the local client.

S250: The link address, which is included in the advertisement request, of the third-party advertisement is extracted, encryption is performed on the link address of the third-party advertisement to obtain a key, and associative storage is performed on the key and the local CDN file address in which the transcoded third-party advertisement is stored.

The process of performing encryption on the link address of the third-party advertisement to obtain the key is the same as the process of step S211, and details are not described herein again. Associative storage is performed on the generated key and the local CDN file address in which the transcoded third-party advertisement is stored, such that the client directly acquires the third-party advertisement from the local CDN file address of the server when the client requests for the third-party advertisement again.

According to the advertisement-downloading method provided by this embodiment of this disclosure, based on the embodiment as illustrated in FIG. 1, by performing encryption on a link address of a third-party advertisement to obtain a key, and performing associative storage on the key and a local CDN file address, a correlation between the link address of the third-party advertisement and the local CDN file address is established, such that the server locally finds, more accurately and quickly, a storage address of the third-party advertisement requested by the client.

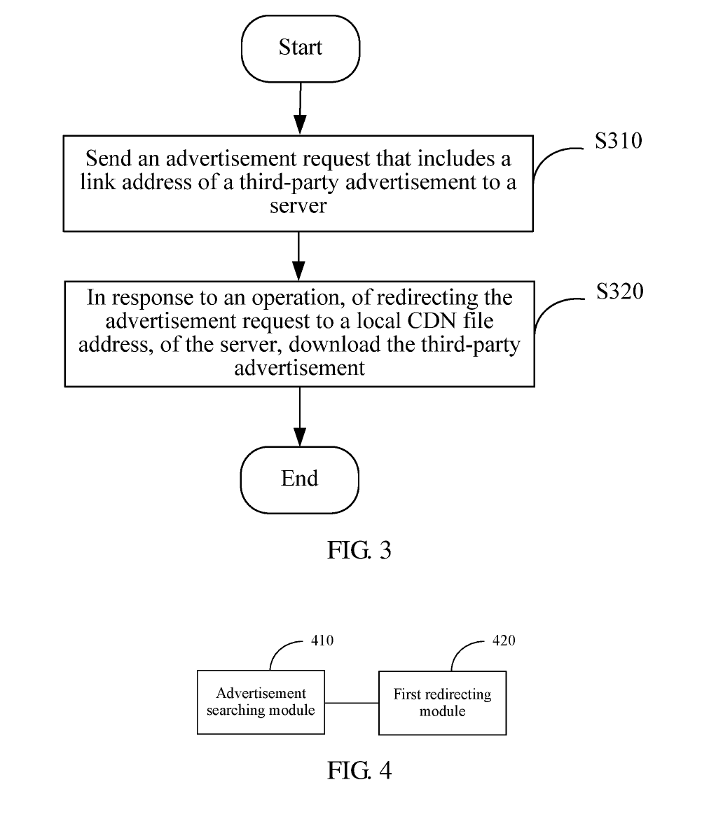

FIG. 3 is a flowchart illustrating an advertisement-downloading method according to still another embodiment of this disclosure; wherein an enforcement object of the method may be a client that sends an advertisement request to a local server (that is, the enforcement object of the above method embodiments). The method steps of this embodiment and the method steps as illustrated in FIG. 1 or FIG. 2 may be performed alternatively.

With reference to FIG. 3, in step S310, an advertisement request that includes a link address of a third-party advertisement is sent to a server.

This step is the same as the prior art. To acquire data of a third-party advertisement, a client first needs to use a local server to acquire a link address of the third-party advertisement, and then send an advertisement request that includes the link address of the third-party advertisement to the local server.

In step S320, in response to an operation, of redirecting the advertisement request to a local CDN file address of the server, of the server, the third-party advertisement from the local CDN file address is downloaded, wherein the third-party advertisement downloaded from the link address of the third-party advertisement is pre-stored in the local CDN file address.

In the prior art, after receiving the advertisement request sent by the client, the server directly redirects the request to the link address of the third-party advertisement, and then the client downloads the third-party advertisement from the link address of the third-party advertisement and plays the third-party advertisement.

In the present solution, to avoid downloading failures due to a bad network environment in which the client downloads the third-party advertisement from the link address of the third-party advertisement, or potential risks, which may not be sensed by the client, of modification of the third-party advertisement, the local server pre-downloads the third-party advertisement from the link address of the third-party advertisement, and stores the third-party advertisement in a local CDN file address.

Therefore, different from the process of the prior art, in this embodiment, after receiving the advertisement request that includes the link address of the third-party advertisement, the server first searches whether the third-party advertisement requested by the above client and downloaded from the link address of the third-party advertisement is pre-stored in the local CDN file address. If the third-party advertisement downloaded from the link address of the third-party advertisement is pre-stored in the local CDN file address of the server, in response to the operation, of redirecting the advertisement request to the local CDN file address of the server, of the server, the client downloads the third-party advertisement from the local CDN file address of the server.

If the third-party advertisement requested in the advertisement request and downloaded from the link address of the third-party advertisement is not stored in the local CDN file address of the server, in response to an operation, of redirecting the advertisement request to the link address of the third-party advertisement, of the server, the client still needs to download the third-party advertisement from the link address of the third-party advertisement.

Referring to content of the above embodiments for samples of the advertisement request that includes the link address of the third-party advertisement, the local CDN file address of the server, and the link address of the third-party advertisement involved in this embodiment.

According to the advertisement-downloading method provided in this embodiment of this disclosure, by pre-downloading, based on a server side, a third-party advertisement stored in a link address of the third-party advertisement into a local CDN, and establishing a correlation between the link address of the third-party advertisement and a local CDN file address, a client first downloads the third-party advertisement in the local CDN file address when requesting for the third-party advertisement each time, thereby improving file downloading speed and quality and ensuring smooth play of the advertisement.

FIG. 4 is a structural block diagram illustrating a server according to one embodiment of this disclosure. The server as illustrated in FIG. 4 may be configured to perform the method steps of the embodiment as illustrated in FIG. 1.

With reference to FIG. 4, the server specifically includes: an advertisement searching module 410 and a first redirecting module 420.

The advertisement searching module 410 is configured to, in response to an operation, of sending an advertisement request that includes a link address of a third-party advertisement, of a client, search whether the third-party advertisement downloaded from the link address of the third-party advertisement is pre-stored in a local CDN file address. The first redirecting module 420 is configured to, when the third-party advertisement downloaded from the link address of the third-party advertisement is pre-stored in the local CDN file address, redirect the advertisement request to the local CDN file address in which the third-party advertisement is stored, such that the client performs advertisement downloading.

According to the server according to this embodiment of this disclosure, by pre-downloading a third-party advertisement stored in a link address of the third-party advertisement into a local CDN, a client first searches for and downloads the third-party advertisement in a local CDN file address when requesting for the third-party advertisement each time, thereby improving file downloading speed and quality and ensuring smooth play of the advertisement.

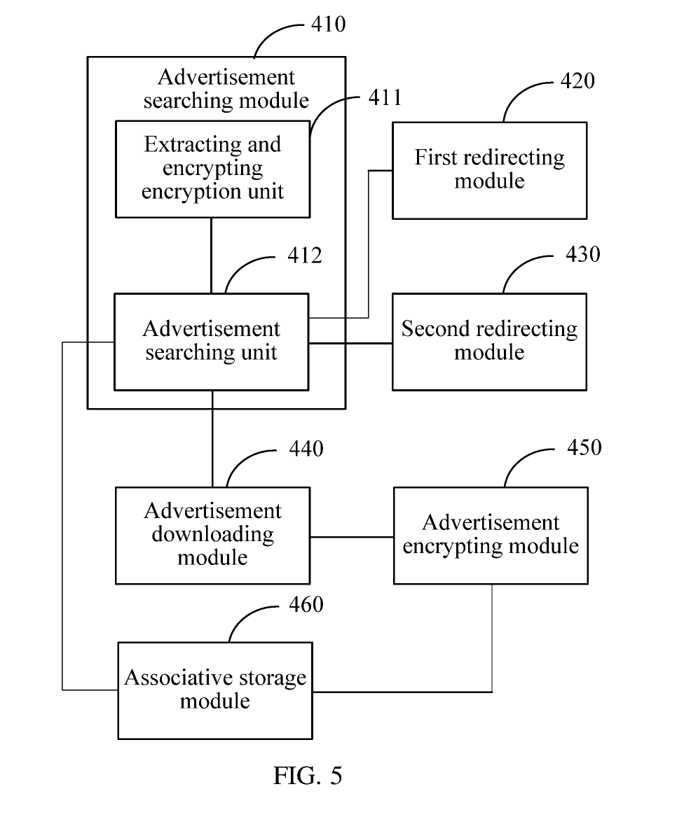

In an embodiment, as illustrated in FIG. 5, in the server, the advertisement searching module 410 specifically includes: an extracting and encrypting unit 411, configured to extract the link address, which is included in the advertisement request, of the third-party advertisement, and perform encryption on the link address of the third-party advertisement to obtain a key; and an advertisement searching unit 412, configured to, query whether a CDN file address stored in association with the key exists locally, and if the CDN file address stored in association with the key exists locally, determine that the third-party advertisement downloaded from the link address of the third-party advertisement is pre-stored in the local CDN file address.

In an embodiment, as illustrated in FIG. 5, the server further includes: a second redirecting module 430, configured to, if the third-party advertisement downloaded from the link address of the third-party advertisement is not found in the local CDN file address, redirect the advertisement request to the link address, in which the third-party advertisement is stored, of the third-party advertisement, such that the client performs advertisement downloading.

In an embodiment, as illustrated in FIG. 5, the server further includes: an advertisement downloading module 440, configured to: download the third-party advertisement from the link address of the third-party advertisement, perform transcoding, and then store the transcoded third-party advertisement into the local CDN file address.

In an embodiment, as illustrated in FIG. 5, the server further includes: an advertisement encrypting module 450, configured to extract the link address, which is included in the advertisement request, of the third-party advertisement, and perform encryption on the link address of the third-party advertisement to obtain the key; and an associative storage module 460, configured to perform associative storage on the key and the local CDN file address in which the transcoded third-party advertisement is stored.

In an embodiment, the advertisement encrypting module 450 is specifically configured to: extract the link address, included in the advertisement request, of the third-party advertisement, and perform MD5 encryption on the link address of the third-party advertisement to obtain the key.

The server as illustrated in FIG. 5 may be configured to perform the method steps of the embodiment as illustrated in FIG. 2.

With this technical solution, by performing encryption on a link address of a third-party advertisement to obtain a key, and performing associative storage on the key and a local CDN file address, a correlation between the link address of the third-party advertisement and the local CDN file address is established, such that the server locally finds, more accurately and quickly, a storage address of the third-party advertisement requested by the client.

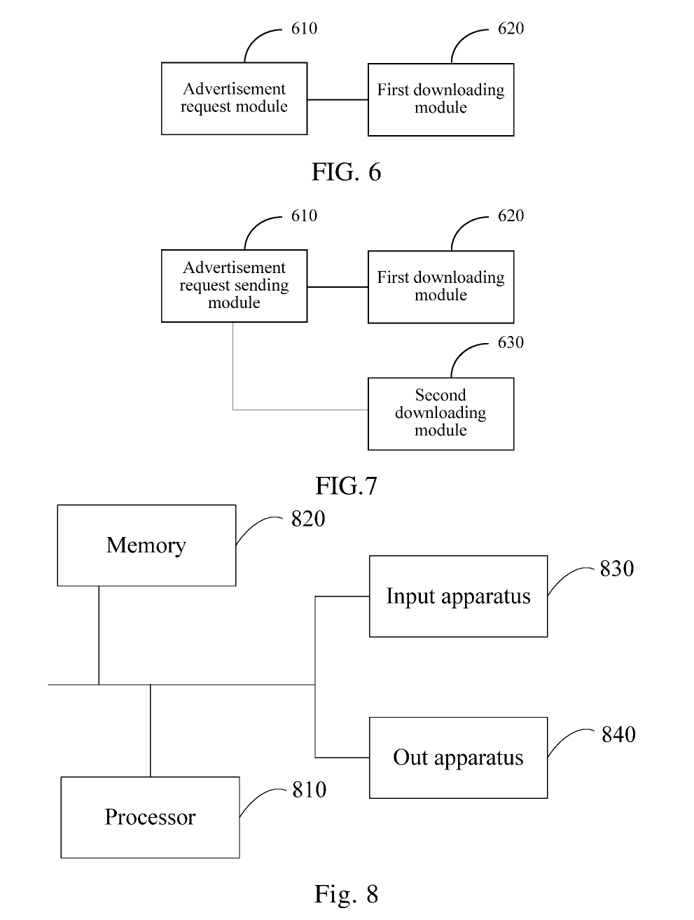

FIG. 6 is a structural block diagram illustrating a client according to one embodiment of this disclosure. The client as illustrated in FIG. 6 may be configured to perform the method steps of the embodiment as illustrated in FIG. 3.

With reference to FIG. 6, the client specifically includes: an advertisement request sending module 610 and a first downloading module 620.

The advertisement request sending module 610 is configured to send an advertisement request that includes a link address of a third-party advertisement to a server. The first downloading module 620 is configured to, in response to an operation, of redirecting the advertisement request to a local CDN file address of the server, of the server, download the third-party advertisement from the local CDN file address, wherein the third-party advertisement downloaded from the link address of the third-party advertisement is pre-stored in the local CDN file address.

In an embodiment, as illustrated in FIG. 7, the client further includes: a second downloading module 630, configured to: if the third-party advertisement downloaded from the link address of the third-party advertisement is not stored in the local CDN file address of the server, then in response to an operation, of redirecting the advertisement request to the link address of the third-party advertisement, of the server, download the third-party advertisement from the link address of the third-party advertisement.

With the client according to this embodiment of this disclosure, by pre-downloading, based on a server side, a third-party advertisement stored in a link address of the third-party advertisement into a local CDN, and establishing a correlation between the link address of the third-party advertisement and a local CDN file address, the client first downloads the third-party advertisement in the local CDN file address when requesting for the third-party advertisement each time, thereby improving file downloading speed and quality and ensuring smooth play of the advertisement.

An embodiment of this disclosure provides a non-volatile computer storage medium, which stores computer executable instructions, where the computer executable instructions may execute the advertisement-downloading method in any the advertisement-downloading method one of the foregoing method embodiments.

A schematic structural diagram of hardware of an electronic device for executing an advertisement-downloading method provided in Embodiment 7 of this disclosure. As shown in FIG. 8, the device includes: one or more processors 810 and a memory 820, where only one processor 810 is used as an example in FIG. 8.

A device for executing the advertisement-downloading method may further include: an input apparatus 830 and an output apparatus 840.

The processor 810, the memory 820, the input apparatus 830, and the output apparatus 840 may be connected by means of a bus or in other manners. A connection by means of a bus is used as an example in FIG. 8.

Memory 820 is a non-volatile computer medium for storing a non-transitory software program, a non-volatile computer program and module, for example the program instructions/module for performing an above described method (e.g. advertisement request module 610, first downloading module 620 and second downloading module 630 shown in FIG. 7). The processor 810 may operate the various functions and data processing of a server to perform the advertisement-downloading method described in the above embodiments by executing non-volatile software programs, instructions and modules stored in the memory 820.

The memory 820 may include a program storage area and a data storage area. Among them, the program storage area may store operation system, disclosure programs of at least one function; the data storage area may store generated data during operation of the electronic apparatus for performing the method described in the above embodiments. In addition, the memory 820 may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the memory 820 may include a storage medium that is remote to the processor 810. The remote storage medium may be connected to the electronic apparatus for performing any of the above methods by a network. The examples of such as network include but not limited to Internet, enterprise intranet, local area network, mobile telecommunication network and a combination thereof.

The input apparatus 830 may receive input number or byte information, and may generate input key information relating to user setting and functional control of the electronic apparatus for performing the method described in the above embodiments. The output apparatus 840 may include a display device such as a display screen.

The one or more modules stored in the memory 820 that, when executed by the one or more processors 810, may perform any of the above described methods.

The above products may perform any of the above described methods, and have corresponding functional modules and effects. Details that are not disclosed in this embodiment may be understood by reference to the above method embodiments of the present disclosure.

An electronic apparatus of the present disclosure may exist in a varied form and includes but not limited to:

(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.

(2) A super-mobile personal computer which belongs to the field of a personal computer and has calculation and processing functions, and in general may access to a mobile network. Such a terminal device includes: a PDA, a MID and a UMPC etc., for example iPad.

(3) A portable entertainment device which is capable of displaying and playing multimedia content. Such a device includes: an audio player, a video player (e.g. iPod), a handheld game console, an electronic book, a smart toy and a portable automotive navigation device.

(4) A server which may provide calculation service and may include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.

(5) Other electronic apparatus that is capable of data exchange

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art may clearly learn that each implementation manner may be implemented by means of software in combination with a universal hardware platform, and certainly, may be also implemented by using hardware. Based on such understanding, the essence, or in other words, a part that makes contributions to relevant technologies, of the foregoing technical solutions may be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she may still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

What is claimed is:

1. An advertisement-downloading method, applied in a terminal, comprising:
in response to an operation, for sending an advertisement request that comprises a link address of a third-party advertisement, by a client, searching whether the third-party advertisement downloaded from the link address of the third-party advertisement is pre-stored in a local CDN file address; and
redirecting the advertisement request to the local CDN file address in which the third-party advertisement is stored, when the third-party advertisement downloaded from the link address of the third-party advertisement is pre-stored in the local CDN file address, such that the client performs advertisement downloading.

2. The method according to claim 1, wherein the in response to an operation, of sending an advertisement request that includes a link address of a third-party advertisement, of a client, searching whether the third-party advertisement downloaded from the link address of the third-party advertisement is pre-stored in a local CDN file address comprises:
extracting the link address, which is comprised in the advertisement request, of the third-party advertisement, and performing encryption on the link address of the third-party advertisement to obtain a key; and
querying whether a CDN file address stored in association with the key exists locally, if the CDN file address stored in association with the key exists locally, determining that the third-party advertisement downloaded from the link address of the third-party advertisement is pre-stored in the local CDN file address.

3. The method according to claim 1, further comprising:
redirecting the advertisement request to the link address, in which the third-party advertisement is stored, of the third-party advertisement, if the third-party advertisement downloaded from the link address of the third-party advertisement is not found in the local CDN file address, such that the client performs advertisement downloading.

4. The method according to claim 3, wherein after if the third-party advertisement downloaded from the link address of the third-party advertisement is not found in the local CDN file address, the method further comprises:
downloading the third-party advertisement from the link address of the third-party advertisement, performing transcoding, and storing the transcoded third-party advertisement into the local CDN file address.

5. A non-volatile computer storage medium, which stores a computer executable instructions that, when executed by an electronic device, cause the electronic device to:
in response to an operation, send an advertisement request that includes a link address of a third-party advertisement, of a client, search whether the third-party advertisement downloaded from the link address of the third-party advertisement is pre-stored in a local CDN file address; and
when the third-party advertisement downloaded from the link address of the third-party advertisement is pre-stored in the local CDN file address, redirect the advertisement request to the local CDN file address in which the third-party advertisement is stored, such that the client performs advertisement downloading.

6. The non-volatile computer storage medium according to claim 5, wherein the in response to an operation, send an advertisement request that includes a link address of a third-party advertisement, of a client, search whether the third-party advertisement downloaded from the link address of the third-party advertisement is pre-stored in a local CDN file address:
extracting the link address, which is included in the advertisement request, of the third-party advertisement, and performing encryption processing on the link address of the third-party advertisement to obtain a key; and
querying whether a CDN file address stored in association with the key exists locally, if the CDN file address stored in association with the key exists locally, determining that the third-party advertisement downloaded from the link address of the third-party advertisement is pre-stored in the local CDN file address.

7. The non-volatile computer storage medium according to claim 5, wherein the computer executable instructions are further set as:
if the third-party advertisement downloaded from the link address of the third-party advertisement is not found in the local CDN file address, redirecting the advertisement request to the link address, in which the third-party advertisement is stored, of the third-party advertisement, such that the client performs advertisement downloading.

8. The non-volatile computer storage medium according to claim 7, wherein after the if the third-party advertisement downloaded from the link address of the third-party advertisement is not found in the local CDN file address, cause the electronic device to:
download the third-party advertisement from the link address of the third-party advertisement, perform transcoding, and then storing the transcoded third-party advertisement into the local CDN file address.

9. An electronic device, comprise:
at least one processor; and
a memory communicably connected with the at least one processor
to store instructions executable by the at least one processor, where execution of the instructions by the at least one processor causes the at least one processor to:
in response to an operation, send an advertisement request that includes a link address of a third-party advertisement, of a client, search whether the third-party advertisement downloaded from the link address of the third-party advertisement is pre-stored in a local CDN file address; and
when the third-party advertisement downloaded from the link address of the third-party advertisement is pre-stored in the local CDN file address, redirect the advertisement request to the local CDN file address in which the third-party advertisement is stored, such that the client performs advertisement downloading.

10. The electronic device according to claim 9, wherein the in response to an operation, is configured to send an advertisement request that includes a link address of a third-party advertisement, of a client, search whether the third-party advertisement downloaded from the link address of the third-party advertisement is pre-stored in a local CDN file address comprises:
extract the link address, which is included in the advertisement request, of the third-party advertisement, and perform encryption processing on the link address of the third-party advertisement to obtain a key; and
query whether a CDN file address stored in association with the key exists locally, if the CDN file address stored in association with the key exists locally, determine that the third-party advertisement downloaded from the link address of the third-party advertisement is pre-stored in the local CDN file address.

11. The electronic device according to claim 9, wherein the at least one processor is further caused to:
if the third-party advertisement downloaded from the link address of the third-party advertisement is not found in the local CDN file address, redirect the advertisement request to the link address, in which the third-party advertisement is stored, of the third-party advertisement, such that the client performs advertisement downloading.

12. The electronic device according to claim 11, wherein after the if the third-party advertisement downloaded from the link address of the third-party advertisement is not found in the local CDN file address, cause the at least one processor to:
download the third-party advertisement from the link address of the third-party advertisement, perform transcoding, and then storing the transcoded third-party advertisement into the local CDN file address advertisement downloading method
